(19) United States
(12) Patent Application Publication
(10) Pub. No.: US 2025/0217514 A1
(43) Pub. Date: Jul. 3, 2025

(54) Methods and Systems of a Somatic Artificial Intelligence Data System (SAIDS)

(71) Applicant: John David Fitzsimmons, JR., Phoenix, AZ (US)

(72) Inventor: John David Fitzsimmons, JR., Phoenix, AZ (US)

(21) Appl. No.: 19/003,123

(22) Filed: Dec. 27, 2024

Related U.S. Application Data
(60) Provisional application No. 63/616,528, filed on Dec. 30, 2023.

(51) Int. Cl. G06F 21/62

(52) U.S. Cl. CPC G06F 21/6254

(57) ABSTRACT

The Somatic Artificial Intelligence Data Systems (SAIDS) invention provides a method, system and apparatus for user-controlled data curation, privacy, and monetization. Leveraging a Generative Artificial Intelligence Agent (GAIA), SAIDS enables the collection and real-time processing of multimodal data, including biometric and environmental inputs, through wearable or standalone devices. GAIA anonymizes data, detects unauthorized use via integrity checks, and supports user decisions to either opt-in for economic benefits through data sharing or opt-out for enhanced privacy. This system democratizes data ownership by empowering users to retain control and derive value from their personal data in a privacy-preserving manner.

### CROSS-REFERENCE TO RELATED APPLICATIONS

This application is entitled to the benefit of Provisional Patent Application Ser. No. 63/616,528 filed Dec. 30, 2023.

### BACKGROUND OF THE INVENTION

This invention, the Somatic Artificial Intelligence Data System (SAIDS), relates generally to privacy protection, data monetization, and user-controlled data systems using artificial intelligence (AI) data curation.

### PRIOR ART

The explosion of data collection and its potential applications has driven numerous innovations in privacy protection, data monetization, and user-controlled data systems. Various prior art systems and methods provide context for the novel aspects of the Somatic Artificial Intelligence Data Systems (SAIDS) invention.

1. Digital Consolidation Systems (US_20230237349_A1): This invention addresses centralized data management by consolidating disparate data sources into a unified system. It emphasizes ease of data aggregation and improved accessibility for end-users. However, it lacks mechanisms for real-time user-controlled anonymization and monetization of data assets. Unlike SAIDS, it does not focus on opt-in/opt-out economic models or privacy-centric AI-driven cross-checks to prevent unauthorized data usage.

2. Smart Prompts and AI-Based Digital Representation (US_20220014352_A1): This system employs AI for generating personalized digital interactions and encrypted communication methods. While it integrates AI, its focus is on enhancing user engagement and steganographic encryption, rather than offering a holistic framework for data privacy, user control, and monetization as seen in SAIDS. The SAIDS framework surpasses this by correlating multimodal data and enabling user-driven economic participation.

3. Data Futures Platform (US_20220188925_A1): This patent highlights a platform for trading data as a commodity, emphasizing futures contracts for data assets. Although it presents an economic model for data use, it is not equipped to handle real-time data curation, privacy protection, or multimodal data streams as comprehensively as SAIDS. SAIDS uniquely integrates privacy-preserving generative AI agents and somatic-environmental data correlation.

4. Anonosizing Data with AI (U.S. Pat. No. 10,043,035 B2): This invention introduces systems for enhancing data protection by anonymizing structured and unstructured data using dynamically changing identifiers (DDIDs). While it offers strong privacy controls, it does not address the proactive detection of unauthorized data usage or enable economic models for user monetization of data assets, which are critical elements of SAIDS.

5. Revenue Collection from Personal Data Assets (US_20110313915_A1): This system allows users to monetize their personal data assets through a centralized platform, sharing revenue with users based on data usage. However, it lacks integration with AI-driven privacy mechanisms or somatic-environmental data fusion for advanced applications. SAIDS builds upon this concept by offering a more secure, privacy-focused approach that enables real-time control and multimodal data transformation.

6. User Data Management Platform (U.S. Pat. No. 12,100,025 B2): This platform enables user-controlled data sharing and storage but does not integrate AI-driven anonymization or economic frameworks for data monetization. Additionally, it does not consider somatic data or multimodal inputs in its data management approach. SAIDS distinguishes itself by offering a real-time, privacy-centric, user-first economic model.

The SAIDS invention addresses gaps in the prior art by integrating AI-driven data curation, privacy-preserving transformations, and an economic framework for user-controlled data monetization. It uniquely combines somatic and environmental data for AI applications while ensuring users retain control over their data. These features position SAIDS as a significant advancement in data privacy and economic empowerment for individuals.

### SUMMARY OF THE INVENTION

Data in all forms is becoming the currency of modern economies, including massive datasets employed in the training of Artificial Intelligence (AI) systems. We are running out of data for AI systems and other endeavors. The present invention, Somatic Artificial Intelligence Data Systems (“SAIDS”), is a method and means of personal data curation and transfer, wherein large data collection is enabled and the user as collector retains control of their data. A method and means for a Generative Artificial Intelligence Agent (“GAIA”) to curate a collection of data is enabled whereby the user maintains privacy and active control of which data is stored and potentially transferred. Data transference will comprise the user either opting-in or opting-out of transfer of personal data to other datasets, possibly AI training datasets, public databases or any other entity with data needs. An economic model is enabled whereby the user receives economic benefits from sharing of this data. You may get paid for your data. The alternative opting-out methods and means provide for retention of personal data with additional methods and means of privacy confirmation through AI comparisons to these other, nonpersonal datasets. The pilfering of personal data for AI training and other unauthorized uses is detected and can be dealt with according to data propriety laws. Copyright, trademark and other Intellectual Property (IP) violations may be rectified. The user truly owns their data.

### BRIEF DESCRIPTION OF THE FIGURES

A clear understanding of the key features of the invention summarized above may be had by reference to the appended figures, which illustrate the method and system of the invention, although it will be understood that such figures depict preferred embodiments of the invention and, therefore, are not to be considered as limiting its scope with regard to other embodiments which the invention is capable of contemplating.

FIG. 1: Somatic AI Data Systems (SAIDS)-Big Picture

FIG. 2: SAIDS: Opt-In Economic Model

FIG. 3: SAIDS: Opt-In Economic Model Part II

FIG. 4: SAIDS: Opt-Out Data Checking

FIG. 5: SAIDS: Parallel Data Collection

FIG. 6: SAIDS: Comprehensive Data Sourcing

FIG. 7: SAIDS: Somatic Data source Correlation

FIG. 8: SAIDS: Somatic Data Fuels MultiModality/Robotic Mimicry

FIG. 9: SAIDS—AI Agent Data Transformation & Anonymizing: Curation of Location

FIG. 10: GAIA Face Masking/Transformation

FIG. 11: GAIA Body Masking/Transformation

FIG. 12: GAIA Other IP Masking/Transformation/Obfuscation

FIG. 13: GAIA Voice Masking/Transformation

FIG. 14: GAIA Audio Background Selective Masking/Transformation

FIG. 15: SAIDS—AI Agent Data Curation of Speech & Text

FIG. 16: GAIA Composite Masking in Real World complex Scene

FIG. 17: SAIDS—AI Agent Data Curation of Video & Pictures

FIG. 18: SAIDS—AI Agent Data Curation by Command

FIG. 19: SAIDS—AI Agent Total Curation & Transfer by Command

FIG. 20: SAIDS: How to Use It: AI Agent Training

FIG. 21: SAIDS: Embodiments linked to Cellphone

FIG. 22: SAIDS: Standalone Embodiments without Cellphone

FIG. 23: SAIDS: Watchlike Embodiment in Use

FIG. 24: SAIDS: AI Agent: How to Make It

FIG. 25: SAIDS: AI Agent: How to Make It: Hardware/Hardware Schematic High Level

FIG. 26: SAIDS: How to Make It: LLM GPT Software

### REFERENCE NUMERALS IN FIGURES

50 User comprehensive Data sources

52 Generalized Artificial Intelligence Agent (GAIA)

54 Iterative process

56 Curated data flow/transmission

58 Data Transfer Decision Branch

60 Opting-Out Decision data flow

62 Opting-In Decision data flow

64 Users opting-out of sharing data

66 Users opting-in to sharing data

68 Curated Data opted-in and shared for Training and Other Uses

70 Economic benefits of data sharing through opting-in (e.g. money)

72 Any possible data sources via activities/environment/somatic data

74 Data input device or sensor (e.g. smartphone camera, microphone, etc.)

76 Pilfering Detection/Data sovereignty algorithms

78 Data destination Options when Opting-In

80 Potential SAIDS data purchasers/licensees

82 Sensor for Parallel Data Collection

84 Parallel Data Collection of text or other written & visual information

86 Parallel Data Collection of keyboard input data via visual and/or audio sounds

88 Parallel Data Collection of visual information using lipreading by GAIA

90 Comprehensive Data sources including any legacy, social media or

92 Somatic data sources

94 Somatic data after GAIA curation and correlation

96 User activity with GAIA somatic & correlated data collection

98 Resultant Emulation/Robotic Mimicry thru SAIDS/GAIA methods and means

100 User original raw positional data

102 GAIA transformed positional data

104 User original raw visual appearance data

106 GAIA transformed visual appearance data (anonymization for privacy)

108 Proprietary image original raw visual data

110 Proprietary image GAIA transformed visual data (still and/or video)

112 User original raw voice/audio data

114 GAIA transformed voice/audio data

116 Complex Environment with multiple people and objects

118 User original raw voice/audio data with multiple audio signals

120 GAIA transformed voice/audio data with user trained & selected audio signals transformed or zeroed out

124 User original raw conversational text content

126 GAIA transformed conversational text content

128 GAIA transformed Complex Environment with blanking of visual data to privatize and anonymize people and other objects user has trained GAIA to transform

130 GAIA data blackouts/no recording when in trained private times and locations

132 GAIA Data Curation by Command: User command

134 GAIA Data Curation by Command: GAIA acknowledgement

136 Initial AI Agent Curation Training with Iteration and Feedback through Personal Data Collected and Access given to GAIA

138 SAIDS Embodiments linked to Cellphone/Smartphone

140 SAIDS: Standalone Embodiments without Cellphone

142 SAIDS: Watchlike Embodiments in Use, allowing user data collection first source or in parallel to other data collection

144 Artificial Intelligence as a Service (AlaaS) cloud-based service for GAIA selected outsourcing

146 Local/personal storage & compute resources with user data collection

148 GAIA Hardware

150 GAIA computer-readable medium or software code means

152 GAIA possible Transformer (i.e. GPT) model architecture

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

The inventor claims a method and means of data collection, curation, and transference. The “Somatic Artificial Intelligence (AI) Data Systems” (“SAIDS”) approach is a comprehensive, unobvious and novel system which enables the user (“owner”) to collect a multitude of data, some personal, with benefit of a Generative Artificial Intelligence Agent (“GAIA”) to curate this data as needed. An economic model of “opting-in” or “opting-out” of data transference to other repositories extends the invention's claims. Data ownership and possible sale methods are envisioned.

On 14 Nov. 2023, the inventor John David Fitzsimmons Jr was reading news articles and noted that Artificial Intelligence (AI) systems such as ChatGPT, GPT-4, Bard, Gemini, etc. are running out of data. Not only this limitation, but also data in its totality is oftentimes vacuumed up (i.e. “mined” or “crawled”) from the internet and other sources without the owners' permission. It is a broken system violating the rights of many.

Almost everyone has a plethora of data sources available to them personally. A cellphone. A personal computer/laptop, FitBit. Garmin Fitness tracker, DropBox, old hard disk drive (HDD), etc. The SAIDS could be comprehensive in collecting these data sources and others, either directly from a device or in parallel. An “AI Agent” would collect and curate the user's data as well as facilitate uploading said data to the “Cloud”, other select repositories as well as databases for AI model training. A fundamental condition of the invention is the user/owner retains the rights to her data. If that user “opts-in,” then she is paid for the use of her SAIDS data. If she “opts-out,” then the data is not uploaded to the Cloud or other repositories and methods are envisioned whereby data crosschecking may occur. Data pilfering or data acquired without consent could be detected.

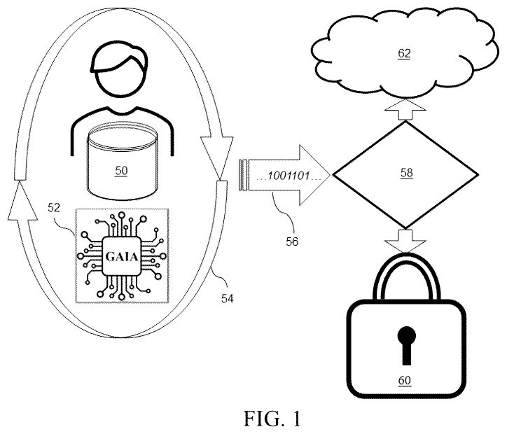

FIG. 1 Somatic AI Data Systems (SAIDS)—Big Picture depicts the SAIDS overview:

1) Personal (“Somatic”) Data Collection 50 and iteration 54,

2) Generative Artificial Intelligence Agent (“GAIA”) 52 Curation with data flow 56, and

3) Transfer Opt-In/Opt-Out 58 decisions to appropriate destinations: Opting-Out Decision data flow 60 repositories & Opting-In Decision data flow 62 repositories.

The collection of data follows a logical flow 56 with this novel AI Agent “GAIA” 52 curating the data. The details of this curation will be comprehensively explained in the specification that follows. The subsequent element of a “Transfer Decision” 58 is the “opt-in” 62 or “opt-out” 60 choice for the user. The methods and means of the invention based on this decision will be explained as well in the specification that follows.

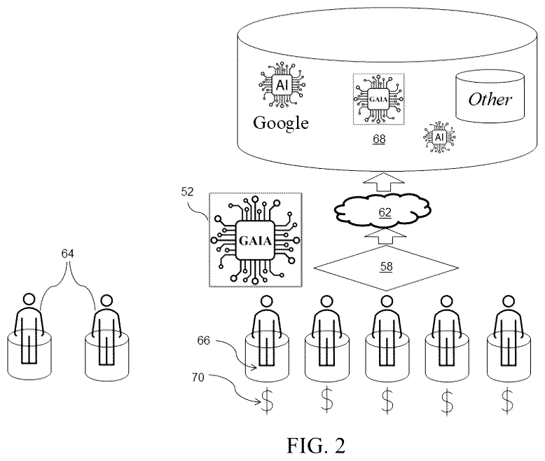

FIG. 2: SAIDS: Opt-In Economic Model depicts the invention's enablement of data ownership and concomitant right to sell said data when opting-in with elements: 64 Users opting-out of sharing data; 66 Users opting-in to sharing data; 68 Curated Data opted-in and shared for Training and Other Uses; 70 Economic benefits of data sharing through opting-in (e.g. money).

Big data needs are potentially fulfilled when many users employ this invention as seen in the figure. This may be a case of highest bidder winning the rights to your data. Subscribing fees are one possibility to compensate the user for the resources of data. People are resigned to paying subscriber fees for many data services such as cable television, NetFlix, Disney+, HBOMax, etc., but now they are able to be paid by subscribers to their data. A nice way to democratize data in the digital AI age.

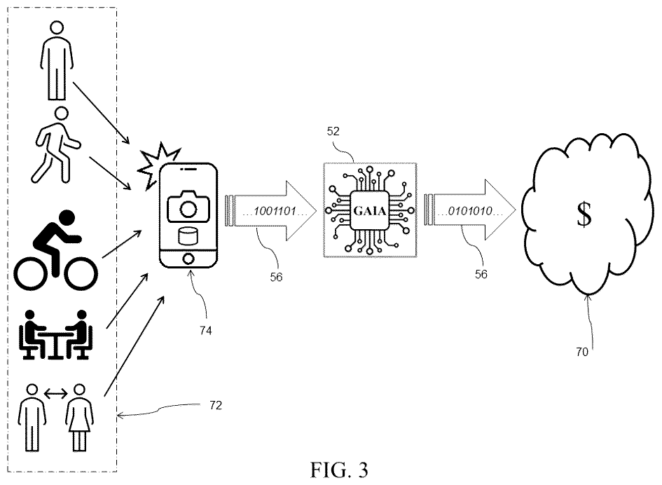

FIG. 3: SAIDS: Opt-In Economic Model Part II lists some of a plethora of data sources included within the economic model. Figure elements are: 70 Economic benefits of data sharing through opting-in (e.g. money); 72 Any possible data sources via activities/environment/somatic data; 74 Data input device or sensor (e.g. smartphone camera, microphone, etc.)

As an economic model, SAIDS encompasses anything within the purview of a personal data source. If it can be collected in electronic form, it can be curated and passed to the transfer decision of opt-in/opt-out. The figure lists “somatic” data which can be from the body or around the user's body. Examples include but are not limited to: a person's location (e.g. latitude, longitude, altitude), visual data collected from a video source, aural or audio data collection such as ambient noises/speech/environmental sounds, etc., haptic/sensation data from pressure transducers or similar means, body state such as a person's blood pressure, heartrate, and temperature, video screens/monitors, keyboard interactions and any other environmental stimuli.

The AI Agent 52 shown in FIG. 3 is the “fulcrum” of the invention. Recent advances in Machine Learning (ML) and Artificial Intelligence (AI) have allowed for a novel implementation of ML/AI methods and means to process & manipulate large quantities of disparate data. The ML/AI technologies of “deep fakes” can interact with video, audio and multimodal data in unprecedented ways and SAIDS is at that frontier level of machines understanding & manipulating data.

Investigating the prior art will not require much digging into the past because the means to implement an AI Agent as envisioned was simply not in existence a very short time ago. Imagine looking for prior art of an electronic computing machine in the Middle Ages—The technology simply did not exist.

Continuing with FIG. 3, it depicts dollar signs within the cloud data symbol 70 to represent the value of data in modern economies. SAIDS allows an individual to reclaim data and its inherent value from large corporations vacuuming it up indiscriminately. Wherever you go, there you are . . . and so is SAIDS to collect data if you the owner choose.

### Personal Data Collection: Data Sources

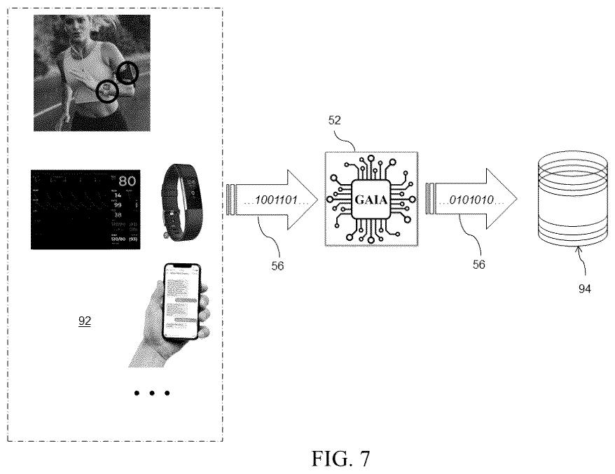

Multimodality offers synergy here, with the term multimodality referring to a combination of multiple sensory and communicative methods, such as sound, video, text, print, images, music, sensory/haptic, and so on, that produce data, analytic or training potential. From a biomedical perspective, multimodality could correlate the body data parameter of heartrate to environmental noise levels (See FIG. 7). After curation by the GAIA AI Agent & opted-in transference, this correlated data might train a FFNN (Feed Forward Neural Network) AI model on noise level effect on human autonomic stress levels. Far more environmental data could be fed into such a system, including body temperature, directed speech, etc. There is nearly limitless opportunity for data usage when SAIDS employs multimodality. In many of the attached figures, we see a range of human activities as a tableau backdrop for the methods and means of the invention. At its summit, the invention would enable comprehensive data collection on all human activity and experience subject to user selection and privacy as needed.

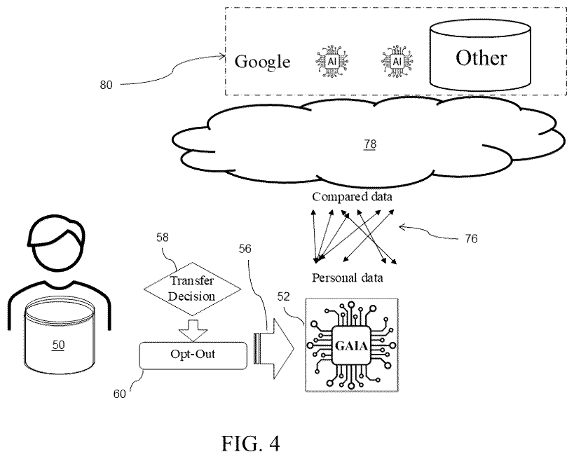

FIG. 4: SAIDS: Opt-Out Data Checking illustrates the flip side to “opting-in” called “opting-out.” Relevant new figure elements are: 76 Pilfering Detection/Data sovereignty algorithms; 78 Data destination Options when Opting-In; and 80 Potential SAIDS data purchasers/licensees.

Given the data collected and curated by the AI Agent, the transfer decision in this case is opting-out 60, not sharing the data but retaining it if selected and running 76 this personal retained data (“GAIA AI Agent Crosscheck”) against available public datasets. As shown, cloud data is compared to personal data with algorithms 76 comprising checksums (i.e. condensed data derived from another block of digital data for the purpose of detecting errors & authenticity), full-factorial token comparisons as well as other algorithms for checking data integrity. A primitive manual analogue is typing your name or Social Security Number (SSN) into Google search and reviewing the hits/results. Any hits of the exact SSN number should not be in the public domain. Similarly, the GAIA AI Agent automatically and continually scans public data to ascertain if your personal data has been pilfered. An example would be an artist having a personal painting in the form of a .png file that could be searched for in public databases (“Cloud”) by the AI Agent. Checksums are one algorithm that the AI Agent could use for pattern recognition against other files. Upon confirmation of appropriation without permission, the user may exercise her rights as needed.

### SAIDS Somatic Definition

According to vocabulary.com, “Somatic is a fancy word that just means dealing with the body.” In this document, somatic applies to both:

1) Body data such as a person's heart rate, blood pressure, temperature, location, etc. AS WELLAS,

2) Somatically worn (i.e. “body-worn”) apparatus for collection of this data and other environmental data such as video and audio.

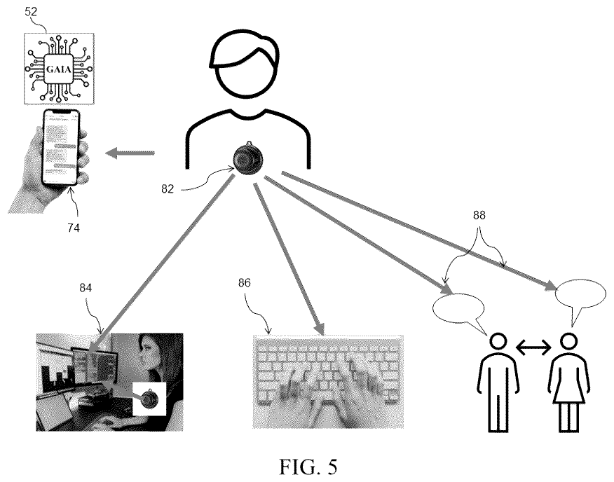

FIG. 5: SAIDS: Parallel Data Collection expands on comprehensive parallel data collection, transformation and anonymization as necessary via the GAIA AI Agent 52 and user's selections 58. Relevant new figure elements are: 82 Sensor for Parallel Data Collection; 84 Parallel Data Collection of text or other written & visual information; 86 Parallel Data Collection of keyboard input data via visual and/or audio sounds; and 88 Parallel Data Collection of visual information using lipreading by GAIA.

Ideally, device compatibility would allow SAIDS to access data directly from other electronic devices such as a FitBit, smart-/cellphone, laptop computer, etc. Unfortunately, some of these devices are restrictive in their data formats and access. SAIDS video and audio sensors would obviate these data roadblocks by intelligently analyzing feeds and distilling data. In the movie “2001: A Space Odyssey,” there is a scene where the HAL 9000 computer is denied access to the audio from the talking astronauts in the pod, but HAL can read their lips. Same principle here—SAIDS employing GAIA would view/listen/access information to something and discern data content through means of artificial intelligence. Speech to text. Type to text. View a monitor and run a means of optical character recognition (OCR) to generate the data that is endemic to that device. Audio AI keyboard “attacks” are becoming commonplace—an AI system can discern what you are typing with only the sound of you clacking away. SAIDS would do the same if not able to access the direct keyboard data or view the keyboard to convert to text. Many heretofore unexplored possibilities open up with an AI Agent coupled to multimodal data. Imagine how a dog can sense an earthquake before it happens by the lower frequencies it hears. Imagine SAIDS with GAIA applying powerful AI methods while viewing and listening at a car dealership and whispering in a person's earbud that the salesman is being deceptive and a better deal can be had. Profound possibilities open up.

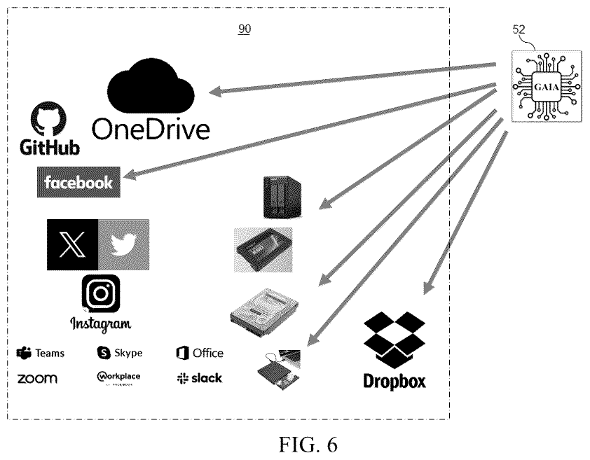

FIG. 6: SAIDS: Comprehensive Data Sourcing reinforces the expansive reach of the methods and means of the invention. Legacy and archival data such as CD-ROM, Hard Disk Drives (HDD), Solid State Drives (SSD), RAIDs, etc. 90 are candidates for SAIDS to curate via the GAIA AI Agent 52. Social Media, video & audio conferencing collaboration, chat, and webinars, cloud storage such as Dropbox and OneDrive may feed data to the personal AI Agent. Previously, a user feeds data to social media platforms day after day and that application retains rights. SAIDS allows for the user to reclaim those rights or, at a minimum, have parallel tracking and storage. If a person desires, every multimodal moment of her life is ripe with an abundance of data. Why not retain and own that data?

FIG. 7: SAIDS: Somatic Data source Correlation ramifies another novelty of SAIDS briefly mentioned above. Somatic data sources 92 such as a person's biomarkers (bodyweight, height, blood pressure, heartrate, temperature, oxygen levels, etc.) are correlated & combined with environmental data collection. By example, multimodality could correlate the body data parameter of heartrate to environmental noise levels. This somatic data after GAIA curation and correlation 94 might train a FFNN (Feed Forward Neural Network) AI model on noise level effect on human autonomic stress levels. With adequate sample size, geographic variation to biomarkers could be analyzed. Example: people living near an airport might have elevated BP and heartrate due to aircraft noise. Note: Somatic Transformation and Anonymizing/Curation/Annotation will be expanded on in subsequent figures.

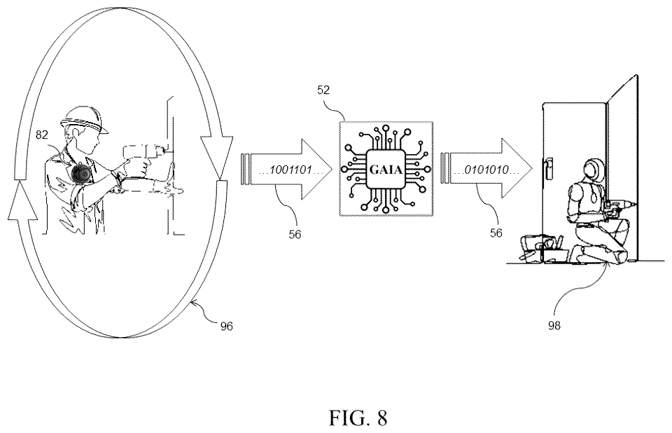

FIG. 8 Emulation/Robotic Mimicry digs deeper at emerging concepts of robotics and human physical behavior emulation/mimicry. Relevant references: 52 Generalized Artificial Intelligence Agent (GAIA); 56 Curated data flow/transmission; 82 Sensor for Parallel Data Collection; 96 User activity with GAIA somatic & correlated data collection; and 98 Resultant Emulation/Robotic Mimicry thru SAIDS/GAIA methods and means.

How does a carpenter replace a door? A chef prepare a delicious entrée? A painter produce a masterpiece? These high-level, advanced mental & physical behaviors require large datasets to train AI systems coupled to means of interaction with the physical world (e.g. robots)—cutting edge AI will fuse machine intelligence with physical capability in the real world (AI brains get brawn). SOMATIC AI (SAIDS) IS THE ANSWER TO TRAINING MACHINE INTELLIGENCE manifesting in useful ways when paired with physical capabilities, producing useful roles in our lives and economy. Sending an EOD robot to defuse an explosive device without putting a person at risk is a current example but these methods and means will extend capabilities far past the current state of the art.

### Data Curation Definition

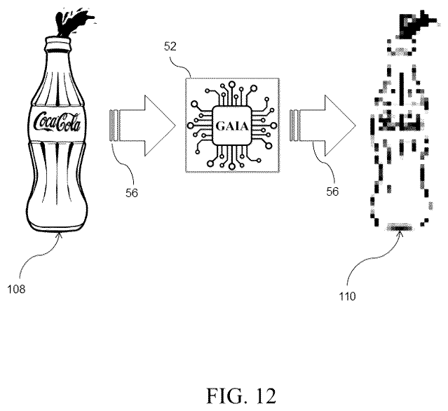

Data curation includes “all the processes needed for principled and controlled data creation, maintenance, and management, together with the capacity to add value to data,” from the online Wikipedia. Also, “Data curation is the process of creating, organizing and maintaining data sets so they can be accessed and used by people looking for information. It involves collecting, structuring, indexing and cataloging data for users in an organization, group or the general public. Data can be curated to support business decision-making, academic needs, scientific research and other purposes,” from the website https://www.techtarget.com/searchbusinessanalytics/definition/data-curation. The term is broad and inclusive of many processes that are designed to organize and give meaning to data throughout its lifecycle. The GAIA AI Agent methods and means of this invention will incorporate a plethora of these processes in an advanced, automatic manner after training and fine-tuning. FIGS. 12-17 will further explain how the AI Agent will curate personal data in the SAIDS.

### SAIDS—AI Agent Data Transformation & Anonymizing

In discussing how the GAIA AI Agent 52 initially fits into the SAIDS process during data creation—The AI Agent will be involved with the transference & data crosschecking in the opting-in or opting out processes as well. The GAIA AI Agent was depicted as a second step in the methods and means of the SAIDS invention but it is integrally involved in all steps of data curation from data collection/creation to transference/disposition to data sovereignty checks.

Specifically, somatic transformation and anonymizing occurs when collected data is accessed by the GAIA AI AGENT and it alters/filters data to preserve data training efficacy while preserving relevant persons' and entities' privacy to the degree specified by the user. A specific example includes transforming any data stream that can reveal identity: names may be transformed from textual streams, audio with speech will transform peoples' names into either pronouns or a pseudonym something like “Jane” or “Person A” based on the fine-tuning the user performed with the GAIA AI Agent. A video will have facial and other physical characteristics transformed to not reveal identities as well. These are very recent technological advancements with AI that the GAIA AI Agent will employ to curate SAIDS data for obfuscation, anonymity and privacy matters. More examples of AI Agent curation are:

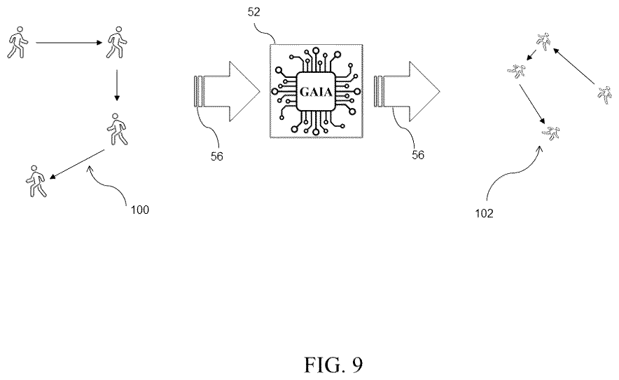

FIG. 9: SAIDS—AI Agent Data Curation of Location is a simple example of the GAIA AI Agent transforming and anonymizing location data. The user's original raw positional data 100 as actual locations are collected and passed to GAIA that may transform the data with a mathematical function such as scaling, translation and rotation (FIG. 9 depiction as GAIA transformed positional data 102). These methods and means could also be bypassed if the user didn't care if location data was shared.

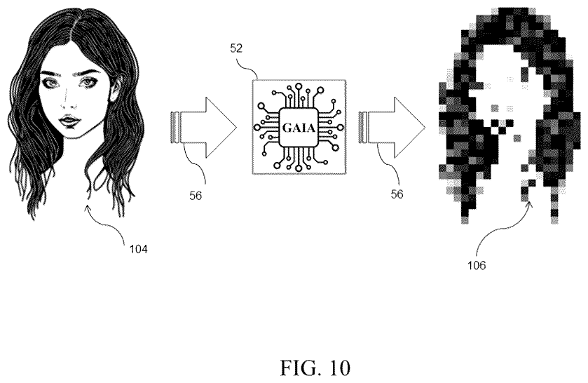

FIG. 10: GAIA Face Masking/Transformation: illustrates visual data obfuscation/transformation by GAIA 52 to anonymize and establish privacy with a person's or entity's face. Relevant references are: 104 User original raw visual appearance data; and 106 GAIA transformed visual appearance data (anonymization for privacy). If the user trains GAIA to anonymize a specific face (or any and all faces as trained), GAIA will curate the image/video data and obfuscate or transform it. 106 in the figure shows pixelization but any methods of data obfuscation are included in the invention's methods. Such methods might comprise blanking, black filling, inverting, randomizing, color alteration. etc. The novelty and power are achieved with GAIA advanced data processing to any and all data the user selected & trained the system on for the methods and means of the invention.

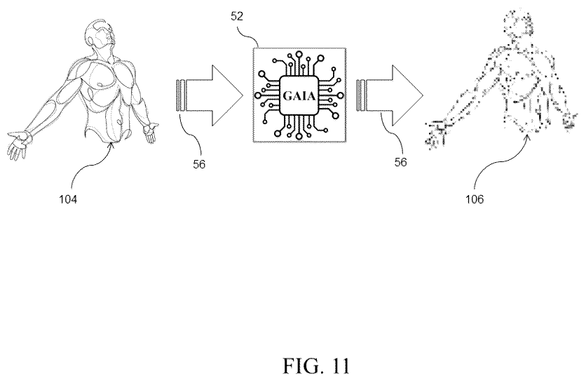

FIG. 11: GAIA Body Masking/Transformation: illustrates visual data obfuscation/transformation by GAIA 52 to anonymize and establish privacy with a person's or entity's body. Relevant references (again) are: 104 User original raw visual appearance data; and 106 GAIA transformed visual appearance data (anonymization for privacy). If the user trains GAIA to anonymize a specific body/physical form (or any and all as trained), GAIA will curate the image/video data and obfuscate or transform it. 106 in the figure shows pixelization but any methods of data obfuscation are included in the invention's methods.

FIG. 12: GAIA Other IP Masking/Transformation/Obfuscation: illustrates visual data obfuscation/transformation by GAIA 52 to anonymize and prevention violation of intellectual property. Relevant references are: 108 Proprietary image original raw visual data; and 110 Proprietary image GAIA transformed visual data (still and/or video). After training, GAIA will apply the same methods to other proprietary data. In the case of FIG. 12, a “Coca Cola” image will be obfuscated to prevent infringement of the brand. With current AI technology, the user might verbalize a command to GAIA as: “GAIA—obfuscate all known trademarks, copyrights and intellectual property that I don't own.” The invention envisions and claims these frontier abilities brought to the user in using the SAIDS invention.

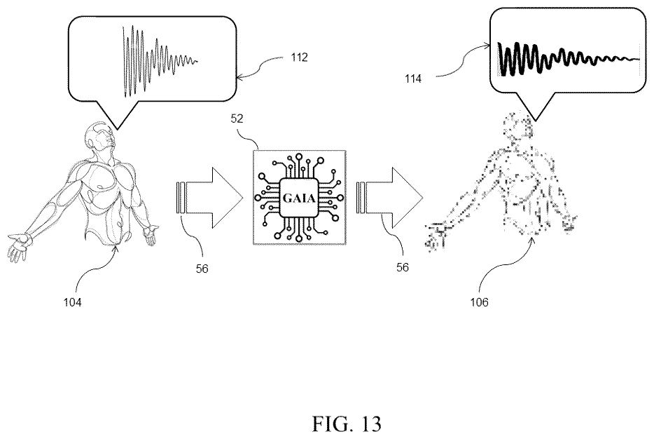

FIG. 13: GAIA Voice Masking/Transformation: State of the technology: “AI-cloned voice scams are on the rise . . . . Scammers just need a few seconds of your voice from social media to create a clone,” an online source reportedly said. “Combined with personal details found online, scammers can convince targets that they are their loved ones. (“How to protect yourself from AI scams this holiday season,” Audrey Nguyen, NPR News, 24 Dec. 2024) This is background and context for the SAIDS methods shown in this figure. Relevant new references: 112 User original raw voice/audio data; and 114 GAIA transformed voice/audio data.

Given bad actors wanting to scam people, GAIA proactively allows for obfuscation and anonymization pf voices captured and processed. Original voices 112 are altered in the GAIA curation into transformed voice/audio data 114, not susceptible to exploitation. As in visual data processing, multiple methods are available to change audio such as frequency modulation (e.g. add or subtract an octave), amplitude modulation and random noise addition to the signal. The user may specify to GAIA.

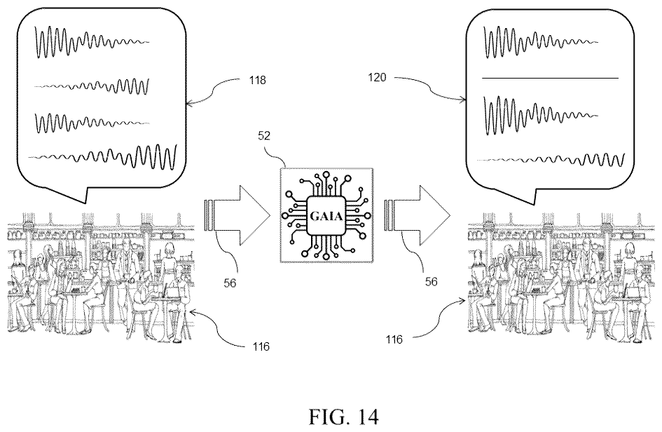

FIG. 14: GAIA Audio Composite Selective Masking/Transformation: extends and ramifies GAIA's audio functions in a complex real-world environment. Relevant new references: 116 Complex Environment with multiple people and objects; 118 User original raw voice/audio data with multiple audio signals; and 120 GAIA transformed voice/audio data with user trained & selected audio signals transformed or zeroed out. The flexibility of training GAIA to anonymize certain voices/channels is evident in the callout 120: Some voices may be unaltered, others blanked or blocked out and others may be radically or subtly obfuscated via alterations of the audio waveform.

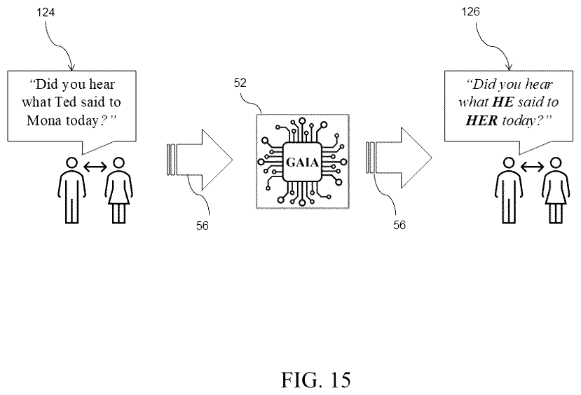

FIG. 15: SAIDS—AI Agent Data Curation of Speech & Text depicts an example of the GAIA AI Agent curating a spoken conversation as alluded to above. Relevant new references: 124 User original raw conversational text content; and 126 GAIA transformed conversational text content.

In reality, the man is asking the woman, “Did you hear what Ted said to Mona today?” 124 and that data stream is passed to GAIA that has been trained & fine-tuned to alter the speech to “Did you hear what he said to her today?” 126 The real names have been changed in the audio data, textual data, video data and any other associated data. Similar to “deep fakes”, the technology exists for this transformation of speech to be nearly seamless—the original speaker's voice can be patterned and replicated to pronounce the anonymized pronouns instead of the real names. Concomitantly, the speaker's voice can be masked and altered in waveform/frequencies if the user has trained GAIA to do so.

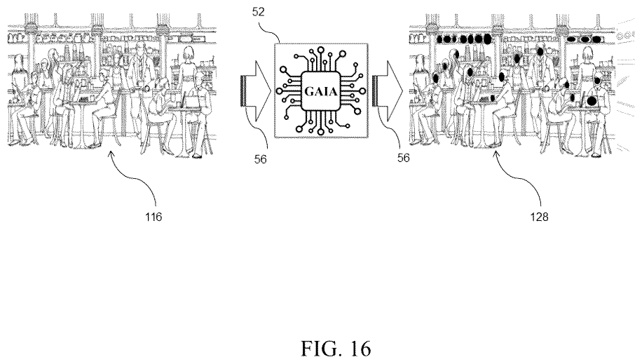

FIG. 16: GAIA Composite Masking in Real World complex Scene: As in FIG. 14 for many audio sources, the real-world visual environment can be quite “messy” and complex. Relevant new reference: 128 GAIA transformed Complex Environment with blanking of visual data to privatize and anonymize people and other objects user has trained GAIA to transform. Same approach but in parallel to a visual scene in still or video data. The user trains GAIA to anonymize certain faces, bodies, objects, IP, etc. 128. Again, the GAIA data obfuscation is occurring within the strategy to monetize these data while preserving privacy.

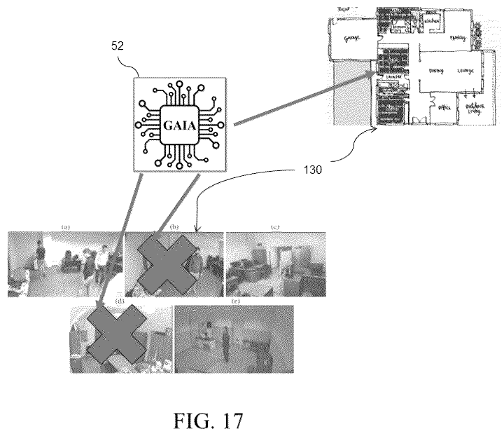

FIG. 17: SAIDS—AI Agent Data Curation of Video & Pictures applies analogous methods and means as detailed for speech/text to video and picture data. The GAIA AI Agent will be trained/fine-tuned to observe data blackouts/no recording when in designated private times and locations 130. The figure has certain rooms in the user's home as private (e.g. bathrooms, bedrooms, etc.) The SAIDS/GAIA methods and means would suspend data collection accordingly. As mentioned, in non-data blackout times, video data collection can anonymize faces and other identifying features of anyone desiring anonymity through the AI Agent.

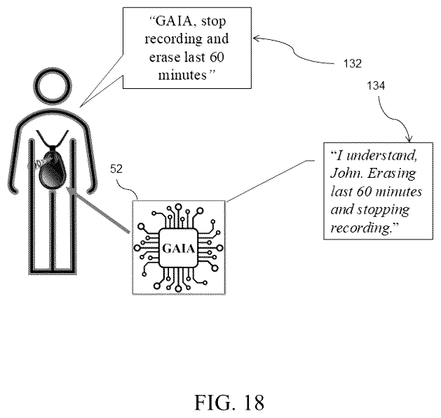

FIG. 18: SAIDS—AI Agent Data Curation by Command depicts the user commanding/training the GAIA AI Agent to start/stop data collection verbally (or with manual input): “GAIA, stop recording and erase last 60 minute.” 132. GAIA acknowledges, “I understand, John. Erasing last 60 minutes and stopping recording” 134. The methods and means of machine learning automation within SAIDS/GAIA can be augmented and modified as needed at any time.

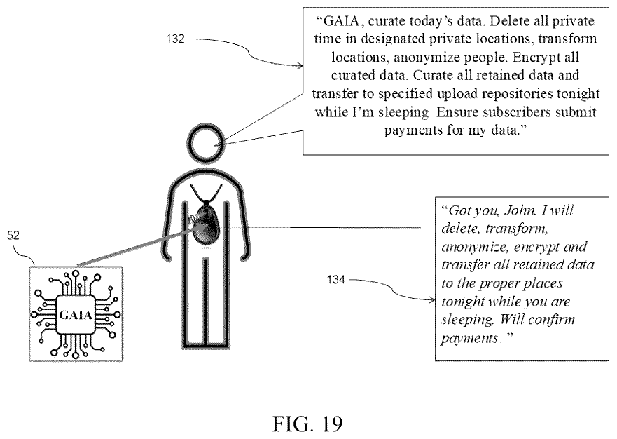

FIG. 19: SAIDS—AI Agent Total Curation & Transfer by Command gives a more comprehensive summary of GAIA in action. The user commands GAIA to transform, anonymize, encrypt, etc. data: “GAIA, curate today's data. Delete all private time in designated private locations, transform locations, anonymize people. Encrypt all curated data. Curate all retained data and transfer to specified upload repositories tonight while I'm sleeping. Ensure subscribers submit payments for my data” 132 The intelligent, always helpful trained GAIA replies, “Got you, John. I will delete, transform, anonymize, encrypt and transfer all retained data to the proper places tonight while you are sleeping. Will confirm payments” 134. The AI Agent will learn this daily/recurring routine and automate the data curation without the user prompting or commands after initial training. Data subscribers provide revenue to the user.

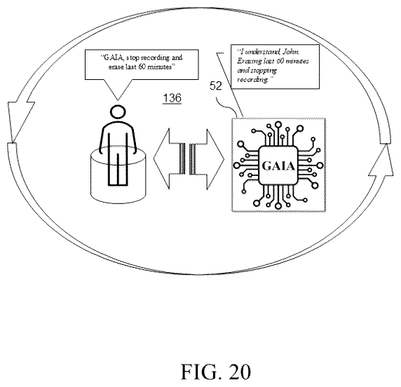

FIG. 20: SAIDS: How to Use It: AI Agent Training expands on processes to teach the GAIA within its roles in the SAIDS invention. Relevant new reference: 136 Initial AI Agent Curation Training with Iteration and Feedback through Personal Data Collected and Access given to GAIA.

Initial training methods and means may be performed at the device manufacturer. Examples of this training comprise such tasks as speech recognition, Optical Character Recognition (OCR), keyboard typing video capture & conversion to ASCII text data, location transformations, encryption, and somatic data stream correlations. Different users will likely have similar needs for basic GAIA functions and this functionality can be trained into the GPT/neural network/algorithms methods and means of SAIDS prior to the user taking ownership. Subsequent to this, each person will train & fine-tune their GAIA AI Agent 136 so the AI Agent will curate personal data properly for filtering/transforming/anonymizing/data labelling/etc. to facilitate the Opt-In Process, if chosen or the Opt-Out Process and concomitant cross-checking of data integrity. One simple example is teaching the AI Agent which places may be off limits for data collection—say bedrooms and bathrooms that will be unique to that user. Also, individual speech recognition will likely need fine-tuning after the user begins using SAIDS.

This specification has given detailed explanation of the processes of SAIDS, now more consideration will be given to the apparatuses that enable the invention.

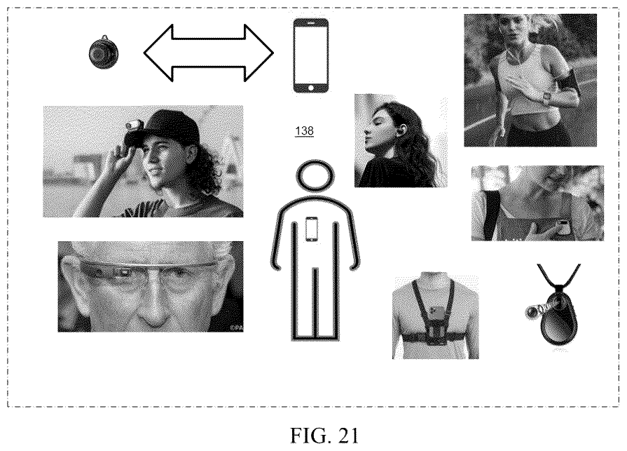

FIG. 21: SAIDS: Ramfications/Embodiments linked to Cellphone shows many ways to implement SAIDS with GAIA. Relevant new reference: 138 SAIDS Embodiments linked to Cellphone/Smartphone.

At the most basic level, a person's cellphone (i.e. “smartphone”) alone with adequate compute and software could fulfill many of the methods and means of the present invention. Said cellphone typically has a video camera and microphone (“mike”) to collect data streams. A scaled-down GAIA could be implemented via this device. To further extend SAIDS, a cellphone cradle/harness mounting the cell to the user's torso is another ramification whereby the cameras face forward and replicate a person's visual field of view. Other Embodiments adding a secondary device linked (e.g. Bluetooth connectivity) to a cellphone comprise an earbud+camera+mike device, a camera+mike pod wearable device, a chest/lapel device, necklace device, watch, glasses and a hat-mounted device. Any location affixed to, on or around the body could be used within the embodiments envisioned.

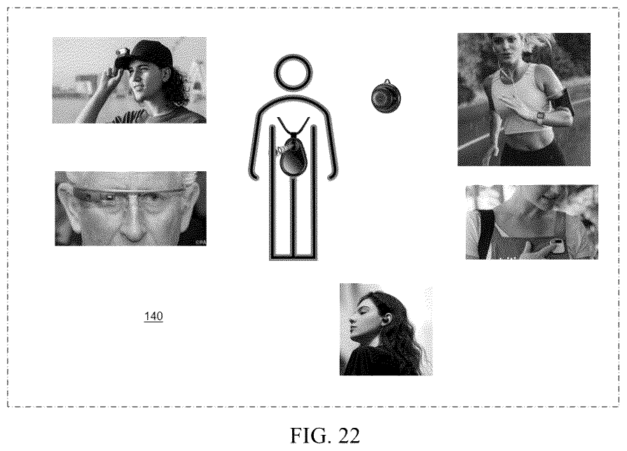

FIG. 22: SAIDS: Standalone Embodiments without Cellphone entails a similar looking depiction of devices to implement SAIDS, but without a cellphone 140. Contrasted to FIG. 19, standalone devices with adequate compute resources and software would fulfill the methods and means of the present invention. A video camera, microphone (“mike”), somatic sensors and so forth would collect data streams, with the GAIA AI Agent implemented via this device without the cellphone or other support hardware. These additional embodiments comprise an earbud+camera+mike device, a camera+mike pod wearable device, a chest/lapel device, necklace device, watch, glasses and a hat-mounted device. Any location affixed to, on or around the body could be used within the embodiments envisioned.

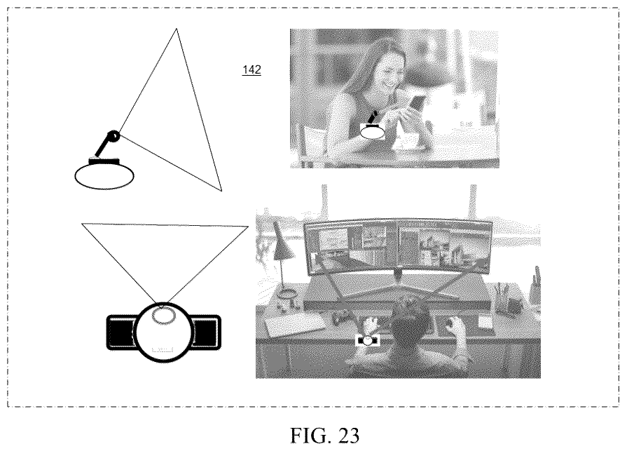

FIG. 23: SAIDS: Watchlike Embodiments in Use demonstrates one potential method and means of implementing SAIDS. It is a functional electronic body-worn device like a watch or FitBit with an energy source (i.e. battery), processor, memory store, body somatic sensors, video/picture lens for input and microphone for audio input 142. This SAIDS embodiment would collect many data sources in parallel with other devices (potential to interface with other devices thru Blue Tooth or similar wireless communication and optional cellphone connectivity.) A novel feature is a lens for video/pix adjustable to see keyboards & screens as needed by movement and telescoping on an adjustable arm mounted to the lens and the body/face of the device.

FIG. 23 also depicts how the device would work in the real world. The SAIDS device can view monitors/keyboard/other apparatuses being interacted with. Video & audio data allow collection of hand placement on cellphone/keyboards/etc. in addition to displays/monitors/etc. GAIA could view and discern content of a person typing or information on a screen/visually as seen in the figure. Again, the GAIA AI Agent can collect data in parallel or connect with devices for the primary data stream.

### SAIDS: GAIA AI Agent: How to Make It

Illuminating the methods and means of building this invention, machine Learning and artificial intelligence (AI) have been around for quite a few decades but have made radical leaps in capabilities in the last years, especially since late 2022 with the release of OPENAI's ChatGPT. Key changes to the structure of Feed Forward Neural Nets with self-attention and Generative Pretrained Transformers (GPTs) have revolutionized the AI landscape. The hardware, with varied processing units like CPU/TPU/GPU/NPU/etc., and software implemented via trained neural networks/GPT's/AI models is evolving quickly. SAIDS will leverage off the latest hardware and software to bring about novel methods & means of data collection, curation and transference. Users will see personal, wearable devices that have compute resources exceeding yesteryear's mainframes and even supercomputers.

More is elucidated in two different phases of AI development: 1) AI training and 2) AI Inference. I asked ChatGPT to explain the two different phases by comparing and contrasting their objectives, goals and resources needed:

“Both phases serve distinct purposes in the development and application of AI models.

### Training Phase:

Objective: The primary goal of the training phase is to teach an AI model to recognize patterns and make predictions based on the input data.

Goal: To optimize the model's parameters by exposing it to large volumes of labeled or unlabeled data, enabling it to learn patterns, correlations, and features.

Resources Needed: The training phase requires substantial computational resources, including high-performance GPUs or specialized hardware like TPUs (Tensor Processing Units). Additionally, large datasets are crucial for training high-performing AI models.

### Process:

Data Preparation: Curating, cleaning, and formatting data for the model's training. This involves labeling data if necessary and splitting it into training, validation, and test sets.

Model Training: Using algorithms like deep learning, the model learns from the data by adjusting its parameters through iterations. This process involves forward and backward passes (forward propagation and backpropagation) to minimize the difference between predicted and actual outputs (the loss function).

Optimization: Fine-tuning the model's hyperparameters (e.g., learning rate, batch size) and architecture to achieve better performance.

Validation: Assessing the model's performance on validation datasets to prevent overfitting and ensure generalizability.

### Inference Phase:

Objective: The main objective during inference is to apply the trained model to new, unseen data and generate predictions or perform tasks based on this data.

Goal: To make accurate predictions, classifications, or perform tasks using the trained model with real-time or batch inputs.

Resources Needed: Inference typically requires fewer resources compared to training. It primarily involves running the trained model on available hardware, such as CPUs, GPUs, or even edge devices.

### Process:

Input Processing: Receiving new data or queries that require AI-based processing or predictions.

Model Execution: Applying the previously trained model to the new data to make predictions, classifications, or generate outputs.

Output Generation: Producing the desired output based on the model's predictions or task performed.

Response Time: Inference often needs to be fast, especially in real-time applications, making latency an essential consideration.

### Comparison:

Objective: Training aims to teach the model patterns from data, while inference applies this learned knowledge to new, unseen data.

Resource Needs: Training demands substantial computational resources and large datasets, while inference requires relatively fewer resources for executing the trained model.

Process: Training involves data preparation, model training, and optimization, whereas inference focuses on input processing, model execution, and generating outputs.

Time: Training is a time-consuming process, often taking hours, days, or even weeks, while inference is typically faster and can be performed in real-time.

In summary, the training phase builds the AI model's knowledge, while the inference phase applies that knowledge to make predictions or perform tasks on new data, with different resource requirements and goals for each phase.”

This lengthy discourse by ChatGPT shows that the SAIDS device/means/methods may be AI trained prior to user acquisition (i.e. “at the manufacturer”) and fine-tuned by the user. The inference methods will occur in real or near real-time during data collection, curation, transference and cross-checking. It's important to remember that much of the SAIDS “software” is the trained neural network or equivalent AI model construct when considering “how to build it.”

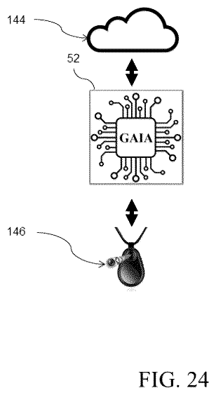

FIG. 24 “How to Make It” further discusses hardware and software implementation by:

1) Artificial Intelligence as a Service (AlaaS) is a cloud-based service offering artificial intelligence (AI) outsourcing 144;

2) Local/personal storage & compute resources 146;

3) Some hybrid or combination of 1 & 2.

The methods and means of the SAIDS invention comprise any compute resources whether local, cloud-based or other. During user data collection, it is possible to share or parallel process GAIA tasks such as curation. Say a person was wearing a SAIDS device to collect data during a walk downtown. This data might be dense with people walking past on a sidewalk and GAIA may need to anonymize these faces and voices while anonymizing location data in real-time. If a non-local data network is available, the audio channels may be passed to AlaaS to parallelize these data curation tasks. Encryption and privacy would be maintained concurrently.

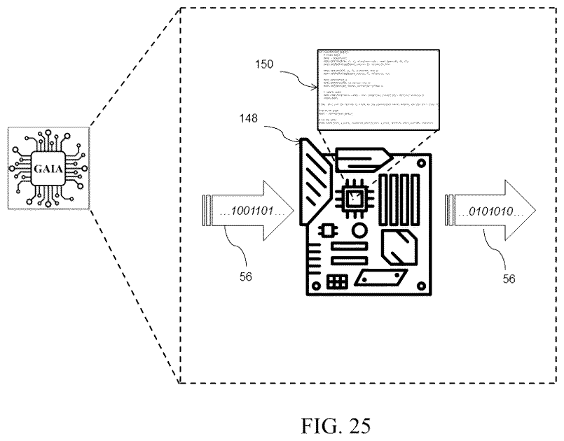

“FIG. 25: SAIDS: AI Agent: How to Make It: Hardware” zooms into a possible hardware and software apparatus of GAIA. Relevant new references: 148 GAIA Hardware; and 150 GAIA computer-readable medium or software/code.

The text reply from another query to ChatGPT further refining computer resources involved in SAIDS:

“Running an AI model like me typically requires substantial computational power and resources, depending on the specific model's size and complexity. Here are the key hardware components typically needed to run AI models:

Central Processing Unit (CPU): CPUs are essential for general-purpose computing tasks. For AI models, having a multicore processor with high clock speeds can help handle parallel computations.

Graphics Processing Unit (GPU): GPUs, especially those designed for parallel processing, are crucial for accelerating the training and inference of deep learning models. NVIDIA's CUDA-enabled GPUs are popular choices due to their optimized architecture for AI workloads.

Memory (RAM): Having ample RAM is crucial for handling large datasets and model parameters efficiently. Deep learning models often require significant memory, so having a high-capacity RAM module is beneficial.

Storage: AI models generate and handle vast amounts of data. Solid State Drives (SSDs) are preferable over Hard Disk Drives (HDDs) due to faster read/write speeds, which can improve model loading times and overall performance.

Specialized AI Processors: Some AI models benefit from specialized hardware, such as TPUs (Tensor Processing Units) developed by Google or other AI-specific accelerators. These processors are designed specifically for deep learning tasks and can significantly speed up computation.

Cluster or Cloud Computing Resources: For larger models or extensive computations, utilizing clusters of machines or cloud-based services (e.g., AWS, Google Cloud Platform, Azure) can provide the necessary scalability and resources on-demand.

The hardware requirements vary based on the size and complexity of the AI model and the intended use—whether it's for training or inference tasks. More complex models with a higher number of parameters typically demand more powerful hardware for efficient execution.

It's essential to consider the specific requirements of the AI model and its intended application when determining the hardware setup needed for optimal performance.”—ChatGPT, 7 Dec. 2023

It's not within the purview of the present specification to delve into the atomics of how to build hardware that can realize the invention. A typical electronic machine with connectivity that might actualize SAIDS has standard compute resources for an electronic computer: storage, means of computation (CPU, GPU, TPU, NPU, . . . ), networking means and methods/means of display and input/output coupled with appropriate sensors, cameras, microphones, etc.

Interestingly, it turns out that current smartphones may be adequate as a minimum viable product to enable the methods and means of the SAIDS invention:

“Large language models can be squeezed onto your phone—rather than needing 1000s of servers to run—after breakthrough. Running massive AI models locally on smartphones or laptops may be possible after a new compression algorithm trims down their size. . . . What we propose in this paper is one technique that is used in combination with techniques proposed in prior works. And I think this combination will enable us to use LLMs on mobile devices more efficiently and get more accurate results.” (LiveScience online by Keumars Afifi-Sabet, Dec. 5, 2024)

The invention here envisioned will not require magic but standard electronic machines that are ubiquitous.

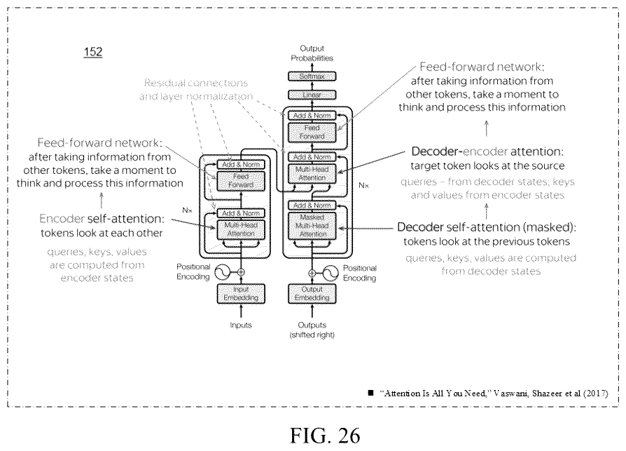

FIG. 26: SAIDS: How to Make It: LLM GPT Software is a depiction of a potential transformer model architecture 152. These self-attentive Feed-Forward Neural Networks and their derivatives are currently some of the most fruitful models for AI capabilities and could be utilized in SAIDS/GAIA. The GAIA AI Agent might leverage large multi-layer networks to process large quantities of data during curation and the other intelligent processes inculcated in the present invention. Like the hardware depictions to enable SAIDS, the exact AI model construct to enable data curation isn't within the purview of this specification-there's more than one way to skin a cat. Some of the data curation functions might be realized with legacy algorithms or “code” of yesteryear. For example, the GAIA task of locational transformation might be performed with a few lines of Python or C++; or the neural networks might transform the data as well. Higher GAIA functions such as “deep fake” analogues to modify speech and video may likely be instituted with most current ML/AI techniques.

### SAIDS: How to Use It

After initial training & fine-tuning, use of the invention will be close to effortless. Charging of the means of the invention are akin to charging of a person's cellphone or other electronic device. Plug it in or drop it into its cradle. The user may choose to collect data by wearing the means of the invention. By example, charging the device could be trained to mean sleep mode with no data collection. These diverse collect conditions are trainable by the user, with manual/speech command override as desired.

Big picture summary: the SAIDS GAIA AI agent will collect, curate and transfer data to specified repositories for the opted-in user. The user may receive funds similar to subscriber fees. The opted-out user will have data integrity crosschecks automated as well. Copyright, privacy and other Intellectual Property (IP) violations may be detected and dealt with according to law.

### SAIDS: Novelty & Unobviousness

Closing with how the present invention is patentable. How is SAIDS different than other methods/means such as users creating & uploading videos to YouTube?

One major difference is integrated AI Agent data curation. The personal GAIA AI Agent acts autonomously after training and automates the high-level personalized process of data collection, curation and transfer when OPTING-IN.

Limitations of the prior art such as YouTube Video Editor require laborious user training and manual involvement to primitively “curate” a video prior to upload.

Somatic data collection and correlation to other data sources are novel and unobvious. A person's location, temperature, BP, etc. is merged with video, audio and other data collection. There are massive possibilities for biosciences and medical research.

The novel economic model of Opt-In or Opt-Out: make money/sell data or data integrity crosschecks to prevent pilfering as envisioned are not available outside of this invention.

I claim:

1. A method for intelligent data curation comprising:
a. Collecting multimodal data, including somatic and environmental inputs, using a user-controlled data collection system;
b. Processing the collected data in real-time through an artificial intelligence agent configured to anonymize, transform, and curate the data based on user-defined preferences;
c. Implementing an opt-in mechanism enabling the monetization of curated data through authorized transfers to specified repositories; and
d. Activating an opt-out mechanism to ensure data privacy by retaining the data and performing cross-checks to detect unauthorized use against public or external datasets.

2. A system for data curation, the system comprising:
a. A multimodal data collection apparatus incorporating somatic sensors, environmental sensors, and a communication interface;
b. A generative artificial intelligence agent configured to curate, anonymize, and transform the data based on user-defined instructions; and
c. A user interface enabling real-time commands for starting, stopping, or modifying data collection and curation processes.

3. A system for user-controlled data monetization and privacy, the system comprising:
a. Means for user participation through opt-in data sharing for economic benefits, wherein curated data is transferred to authorized entities;
b. Means for opting out of data sharing, retaining data locally while performing automated privacy integrity checks to identify unauthorized use; and
c. Mechanisms for user-defined configurations controlling the parameters for data collection, transformation, and sharing.

4. The method of claim 1, wherein the artificial intelligence agent anonymizes the data by transforming identifiers such as names, faces, or locations into anonymized forms.

5. The method of claim 1, wherein the opt-out mechanism employs checksum algorithms to compare user data against public datasets to detect unauthorized duplication.

6. The method of claim 1, wherein the artificial intelligence agent is configured to encrypt curated data before transfer to external repositories.

7. The method of claim 1, further comprising a training phase where the artificial intelligence agent is fine-tuned with user-specific instructions to modify curation behaviors.

8. The system of claim 2, wherein the somatic sensors include biometric sensors configured to measure heart rate, temperature, and geographic location.

9. The system of claim 2, wherein the apparatus is configured for integration with mobile devices to enhance multimodal data collection.

10. The system of claim 2, wherein the generative artificial intelligence agent is operable to anonymize data in real-time by removing or transforming user-specified personal identifiers.

11. The system of claim 2, wherein the user interface includes voice command capability to dynamically adjust data collection parameters.

12. The system of claim 3, wherein the opt-in mechanism includes user-defined terms specifying permissible data uses by authorized entities.

13. The system of claim 3, wherein the opt-out mechanism retains data locally and conducts periodic integrity checks against non-personal datasets.

14. The system of claim 3, wherein the system is configured to notify the user of the results of data integrity checks.

15. The system of claim 2, wherein the data curation apparatus includes sensors for collecting auditory, visual, and textual data streams.

16. The method of claim 1, further comprising correlating somatic data with environmental data to generate multimodal datasets for artificial intelligence training applications.

17. The system of claim 3, wherein the opt-in mechanism includes provisions for anonymization of proprietary visual or audio elements within the curated data.

18. The system of claim 2, wherein the apparatus is configured to collect legacy data from existing digital storage devices for inclusion in multimodal datasets.

19. The method of claim 1, wherein the data curation includes transformation of somatic data into anonymized datasets for robotic mimicry and human emulation applications.

20. The system of claim 2, wherein the generative artificial intelligence agent supports user-defined exclusions for data collection in specific locations or during designated times.
